(19) United States
(12) Patent Application Publication
(10) Pub. No.: US 2016/0141635 A1
(43) Pub. Date: May 19, 2016

(54) FLAT MEMBER FOR FUEL CELL AND METHOD FOR MANUFACTURING FLAT MEMBER

(71) Applicants: TOYOTA JIDOSHA KABUSHIKI KAISHA, Toyota-shi (JP); TOYOTA SHATAI KABUSHIKI KAISHA, Kariya-shi (JP); TOYOTA BOSHOKU KABUSHIKI KAISHA, Kariya-shi (JP)

(72) Inventors: Daisuke KANNO, Toyota-shi (JP); Takashi KONDOU, Nagoya-shi (JP); Yoshinori SHINOZAKI, Toyota-shi (JP); Makoto SAZAWA, Kariya-shi (JP); Satoshi KAWABE, lchinomiya-shi (JP)

(73) Assignees: TOYOTA JIDOSHA KABUSHIKI KAISHA, Toyota-shi (JP); TOYOTA SHATAI KABUSHIKI KAISHA, Kariya-shi (JP); TOYOTA BOSHOKU KABUSHIKI KAISHA, Kariya-shi (JP)

(21) Appl. No.: 14/934,738

(22) Filed: Nov. 6, 2015

(30) Foreign Application Priority Data
Nov. 13, 2014 (JP) 2014-230751

(51) Int. Cl. H01M 8/02; C22C 14/00

(52) U.S. Cl. CPC H01M 8/0232; H01M 8/0256; C22C 14/00

(57) ABSTRACT

To achieve a flat member for fuel cells in which the grain size of titanium is optimized to suppress local elongation and to reduce the siding distance to a punching die, enabling a reduction in ablation of the punching die. The flat member for fuel cells is an expand passage 10a or a separator 10b, and punched out portions 13, 14 are formed in the flat member by, for example, punch pressing. The flat member includes titanium or an alloy of titanium, and the titanium has an average grain size of 15.9 μm or less.

### BACKGROUND OF THE INVENTION

1. Field of the Invention

The present invention relates to flat members such as expand passages and separators for fuel cells.

2. Background Art

Polymer electrolyte fuel cells (PEFCs) are assembled as a fuel cell stack by stacking a plurality of fuel battery cells. Each fuel battery cell is configured to include an electrolyte membrane, a catalyst layer, a gas diffusion layer, and a separator. The separators for fuel cells are typically produced by machining or a similar processing of a metal material, a carbon material, or the like.

The fuel cell separators made of metal materials include uneven separators and flat separators. The flat separator is, for example, produced from a substrate of a metal such as stainless steel and titanium and an electrically conductive film. In the flat separator, punched out portions are formed with a punching press in order to allow a fuel gas to pass through.

As the technique relating to the separators for fuel cells, the following separator for fuel cells is disclosed, for example. The separator includes a metal substrate formed of titanium and an electrically conductive film formed on a surface of the substrate and having electric conductivity. The electrically conductive film contains conductive particles, and the conductive particles have an average particle size of 1 nm or more and 100 nm or less (see Patent Document 1).

### CITATION LIST

### Patent Document(s)

[Patent Document 1] JP2012-190816 A

### SUMMARY OF THE INVENTION

When a conventional fuel cell separator or a similar member that is formed of a metal substrate made of titanium is subjected to punch pressing (shear pressing), a punching the is likely to be abraded, and burrs are likely to rise on the edge of punched out portions. The reason for this is as follows: As shown by the relation between grain sizes of separators for fuel cells and stress-strain curves shown in FIG. 6, a metal substrate made of titanium having a larger grain size has a larger local elongation, which increases the sliding distance between a punching die and the separator. Consequently, the punching die is likely to be abraded and requires more frequent maintenance, increasing the production cost.

In view of the above circumstances, the present invention has an object to provide a flat member for fuel cells in which the grain size of titanium or an alloy of titanium is optimized to suppress local elongation and to reduce the sliding distance to a punching die, enabling a reduction in ablation of the punching die.

To achieve the above object, a flat member for fuel cells of the present Invention includes titanium or an alloy of titanium, and the titanium has an average grain size of 15.9 μm or less.

The flat member for fuel cells of the present invention includes titanium or a titanium alloy that is designed to have a grain size of 15.9 μm or less. This suppresses the local elongation to reduce the sliding distance to a punching die and enables a reduction in ablation of the punching die.

### BRIEF DESCRIPTION OF THE DRAWINGS

FIG. 1 shows a plan view and an enlarged view of an expand passage for fuel cells in an embodiment of the present invention.

FIG. 2 shows a plan view of a separator for fuel cells in an embodiment of the present invention.

FIG. 3 shows a schematic view of a separator for fuel cells and a current collector in an embodiment of the present invention.

FIG. 4 shows a diagram showing the relation between grain sizes of separators for fuel cells of embodiments of the present invention and abrasion resistance of a punching die.

FIG. 5 shows a diagram showing the relation between die abrasion of punched out portions and grain sizes of separators for fuel cells in embodiments of the present invention.

FIG. 6 shows a diagram showing the relation between grain sizes of separators for fuel cells and stress-strain curves.

### DESCRIPTION OF THE PREFERRED EMBODIMENTS

Embodiments of the present invention will now be described. In the drawings, the same or similar elements are indicated by the same or similar signs. The drawings are merely schematically illustrated. Specific dimensions and the like should thus be determined in consideration of the following descriptions. It should be clearly understood that the drawings also include elements having different dimensional relations and ratios from each other.

First, the structure of a flat member for fuel cells in an embodiment of the present invention will be described with reference to the drawings.

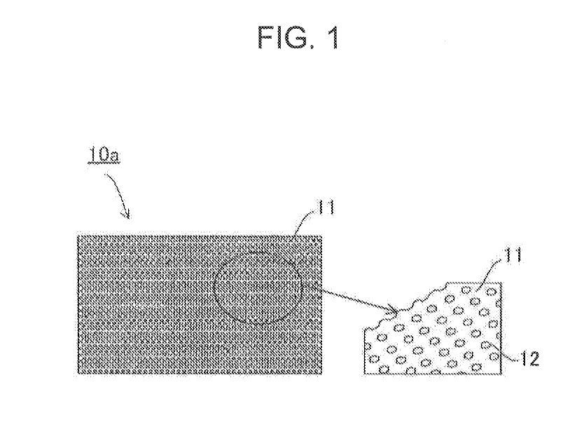

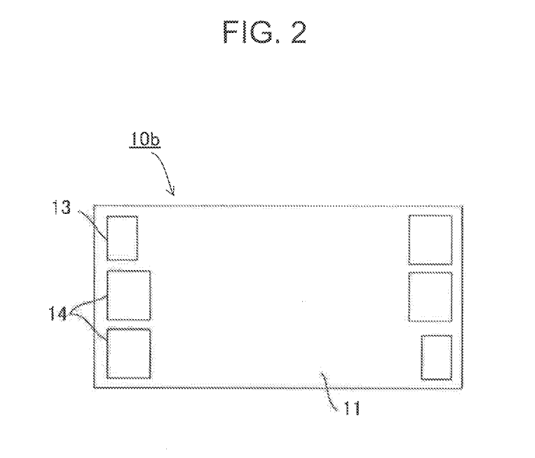

The fuel cell includes a fuel cell stack in which a plurality of fuel battery cells are stacked. The fuel battery cell of a polymer electrolyte fuel cell includes at least a membrane electrode assembly (MEA) in which an ion-permeable electrolyte membrane is interposed between an anode catalyst layer (electrode layer) and a cathode catalyst layer (electrode layer) and a gas diffusion layer for supplying a fuel gas or an oxidant gas to the membrane electrode assembly, which are not shown in the drawings. The fuel battery cell is further interposed between a pair of separators (partition plates). Some fuel battery cells have the structure in which an expand passage is provided between the gas diffusion layer and the separator. The flat member for fuel cells of the present invention includes the expand passage (see FIG. 1) and the separator (see FIG. 2).

FIG. 1 shows a plan view and an enlarged view of an expand passage as the flat member for fuel cells in an embodiment of the present invention. The expand passage 10a is a flat member disposed between a gas diffusion layer and a separator. As shown in FIG. 1, the expand passage 10a of the present embodiment is formed of a porous metal substrate 11. The metal substrate 11 is exemplified by expanded metals. The expanded metal has a continuous structure in which hexagonal meshes are arranged in a staggered pattern on the metal substrate 11. The meshes 12 are formed in the expanded metal by cutting a flat metal substrate 11 to form a plurality of slits and expanding the substrate.

The metal substrate 11 is preferably made of titanium (Ti). The reason for this is as follows: Titanium has high mechanical strength, and on the surface, an inert film such as passive films composed of stable oxides (TiO, Ti₂O₃, TiO₂, for example) is formed. The titanium thus has excellent corrosion resistance. The porous metal substrate 11 of the present embodiment can be made of not only pure titanium but also a titanium alloy.

The average grain size of the metal substrate 11 is preferably set to 15.9 μm or less, which is determined in accordance with the standard of American Society for Testing Materials (ASTM), No. 9.

The expand passage 10a of the present embodiment is formed of a porous metal substrate 11 such as an expanded metal. In other words, a plurality of meshes 12 are arranged In a staggered pattern on the porous metal substrate 11, as shown in FIG. 1. When the meshes 12 arranged in a staggered pattern is disposed between a gas diffusion layer and a separator 10 so as to form a slope, gas passages are alternately disposed between the gas diffusion layer surface and the separator surface. The expand passage 10a is wholly formed by performing shearing work with a punching press.

FIG. 2 is a plan view of a separator as the flat member for fuel cells in an embodiment of the present invention. As shown in FIG. 2, the separator 10b has the structure in which one or more punched out portions 13, 14 are formed in a metal substrate 11. The punched out portions 13, 14 are formed by performing shearing work with a punching press, for example.

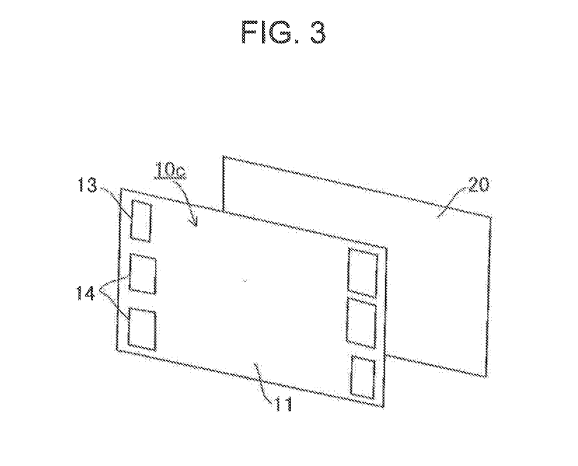

FIG. 3 is a schematic view of a separator for current collectors as the flat member for fuel cells in an embodiment of the present invention and a current collector. As shown in FIG. 3, the separator for current collectors of the present embodiment includes a separator 10c and a current collector 20. The separator 10c is a member that separates fuel battery cells from each other in a fuel cell stack. The separator 10c, as with the separator 10b illustrated in FIG. 2, has the structure in which one or more punched out portions 13, 14 are formed in a metal substrate 11. The separator 10c is in uniform contact with the whole area of an electrolyte membrane as an ion exchange membrane and functions so as to allow hydrogen and air to flow. The separator 10c is particularly bonded to the surface of the current collector 20 to cover the surface of the current collector 20 in order to maintain the corrosion resistance of the current collector 20.

Here, the expand passage 10a as shown in FIG. 1 is produced by cutting a metal substrate 11 through performing shearing work and then shaping the substrate. In the separators 10b and 10c as shown in FIG. 2 and FIG. 3, one or more punched out portions 13, 14 are formed by punch pressing of a metal substrate 11 as a main frame. In the present invention, such a metal substrate 11 is characterized by including titanium or a titanium alloy having a particular grain size range.

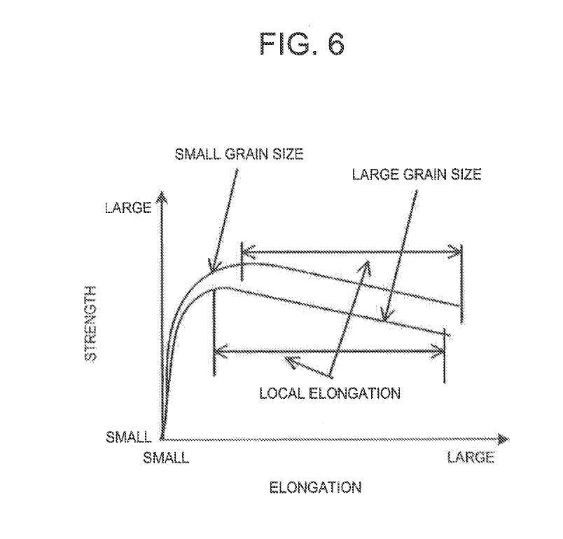

When a conventional expand passage or separator that is formed of a metal substrate made of titanium is subjected to punch pressing, a punching die is likely to be abraded, and burrs are likely to rise on the edge where shearing work is performed. This is because a metal substrate made of titanium having a larger grain size has a larger local elongation, which increases the sliding distance between a punching die and the expand passage or separator (see FIG. 6).

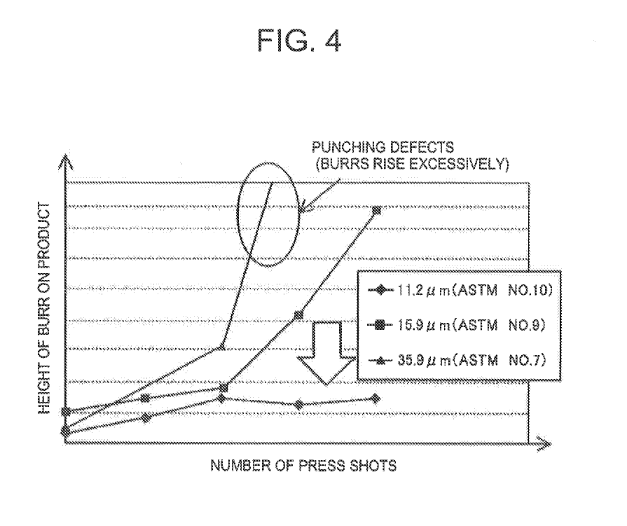

To address this problem, the inventors of the present application have supposed that the defect of conventional expand passages and separators relates to the grain size of titanium constituting the expand passage and separator and have intensively studied the optimum range of average grain size of a metal substrate 11 made of titanium. FIG. 4 is a diagram showing the relation between grain sizes of separators for fuel cells of embodiments of the present invention and abrasion resistance of a punching die. As shown in FIG. 4, in the separator having a grain size of 35.9 μm, which is measured based on No. 7 in the ASTM standard, burrs rise excessively on the punched out portions 13, 14 as the number of press shots increases, causing punching die defects. In the separator having a grain size of 15.9 μm, which is measured based on No. 9 in the ASTM standard, the height of burrs on the punched out portions 13, 14 is low until the number of press shots exceeds a particular value. In the separator having a grain size of 11.2 μm, which is measured based on No. 10 in the ASTM standard, the height of burrs on the punched out portions 13, 14 is low even when the number of press shots increases.

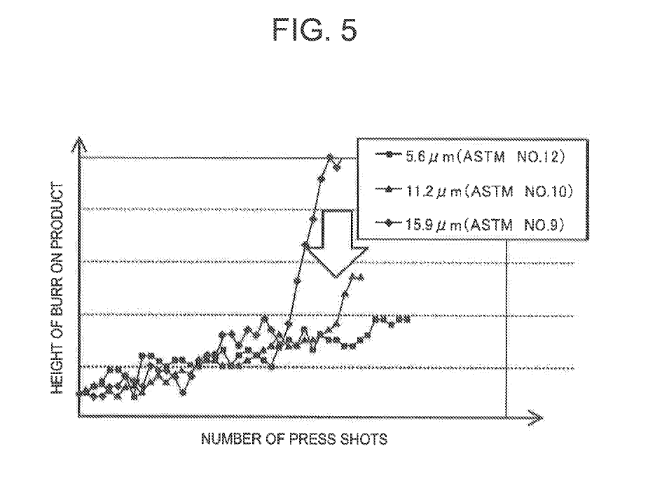

FIG. 5 is a diagram showing the relation between die abrasion of punched out portions and grain sizes of separators for fuel cells in embodiments of the present invention. As shown in FIG. 5, in the separator having a grain size of 15.9 μm, which is measured based on No. 9 in the ASTM standard, the height of burrs on the punched out portions 13, 14 is low until the number of press shots exceeds a particular value. In the separator having a grain size of 11.2 μm, which is measured based on No. 10 in the ASTM standard, and in the separator having a grain size of 5.6 μm, which is measured based on No. 12 in the ASTM standard, the height of burrs on the punched out portion 13, 14 gently increases even when the number of press shots increases.

These studies reveal that the average grain size of the titanium or the titanium ahoy constituting the metal substrate 11 is preferably set to not more than 15.9 μm, which is measured based on No. 9 in the ASTM standard, and more preferably set to not more than 11.2 μm, which is measured based on No. 10 in the ASTM standard.

As described above, in the flat member for fuel cells (for example, an expand passage or a separator) of the present embodiment, the average grain size of titanium or a titanium alloy is optimized to 15.9 μm or less. This suppresses the local elongation to reduce the sliding distance between a punching die and the separator 10, achieving an excellent effect of reducing the abrasion of the punching die.

Although the present invention has been described as above with reference to the embodiments, it should not be understood that the description and drawings, which are parts of the disclosure, limit the invention. The disclosure should clearly show various alternative embodiments, examples, and operational techniques to a person skilled in the art. It should be understood that the present invention encompasses various embodiments and the like that have not been described herein.

The present invention is applied to the following aspects.

(1) An expand passage for fuel cells, the expand passage comprising titanium or a titanium alloy has an average grain size of 15.9 μm or less.
(2) A separator for fuel cells, the separator comprising titanium or a titanium alloy has an average grain size of 15.9 μm or less.
(3) In the expand passage for fuel cells according to the above aspect (1) or the separator for fuel cells according to the above aspect (2), a punched out portion is formed, and the punched out portion is formed by punch pressing.

In the present specification, “the standard of ASTM” means the method for measuring the average grain size defined by ASTM E112-10.

### REFERENCE SIGNS LIST

10a expand passage
10b, 10c separator
11 metal substrate
12 mesh
13, 14 punched out portion
20 current collector

What is claimed is:

1. A flat member for fuel cells, comprising titanium or an alloy of titanium,
the titanium or the alloy of titanium having an average grain size of 15.9 μm or less.

2. The flat member according to claim 1, wherein the flat member is a porous metal substrate.

3. The flat member according to claim 2, wherein the porous metal substrate has a hexagonal mesh structure.

4. The flat member according to claim 2, wherein the flat member is an expand passage.

5. The flat member according to claim 1 wherein the flat member has a punched out portion.

6. The flat member according to claim 5, wherein the flat member is a separator.

7. A method for manufacturing a flat member for fuel cells, comprising:
a step for preparing a flat member, the flat member comprising titanium or an alloy of titanium; and
a step for performing shearing work on the flat member,
wherein the titanium or the alloy of titanium has an average grain size of 15.9 μm for less.

8. The method according to claim 7, wherein in the step for performing shearing work, the flat member is sheared by a punching press with a punching die.

9. The method according to claim 7, before the step for performing shearing work, further comprising:
a step for cutting the flat member to form a plurality of slits in the flat member; and
a step for expanding the flat member in which the plurality of slits are formed.

10. The method according to claim 7, wherein in the step for performing shearing work, a punched out portion is formed in the flat member.
